(19) United States
(12) Patent Application Publication
(10) Pub. No.: US 2019/0012789 A1
(43) Pub. Date: Jan. 10, 2019

(54) GENERATING A DISPARITY MAP BASED ON STEREO IMAGES OF A SCENE

(71) Applicant: Heptagon Micro Optics Pte. Ltd., Singapore (SG)

(72) Inventor: Florin Cutu, San Jose, CA (US)

(21) Appl. No.: 15/745,146

(22) PCT Filed: Jul. 13, 2016
(86) PCT No.: PCT/SG2016/050328

§ 371 Date: Jan. 16, 2018

Related U.S. Application Data
(60) Provisional application No. 62/194,912, filed on Jul. 21, 2015.

(51) Int. Cl. G06T 7/11; G06K 9/62; G06K 9/46; G06T 7/187

(52) U.S. Cl. CPC G06T 7/11; G06K 9/6202; G06T 2207/10024; G06T 7/187; G06T 2207/10012; G06K 9/4652

(57) ABSTRACT

First and second stereo images are acquired. The first image is partitioned into multiple segments, wherein each segment consists of image elements that share one or more characteristics in common. A segmentation map is generated in which each of the image elements is associated with a corresponding one of the segments to which it belongs. A respective disparity value is determined for each of the segments with respect to a corresponding portion of the second image, and the disparity value determined for each particular segment is assigned to at least one image element that belongs to that segment. A disparity map indicative of the assigned disparity values can then be generated. Generating the disparity map in this manner can, in some instance, help reduce edge and/or feature thickening.

### TECHNICAL FIELD

This disclosure relates to image processing and, in particular, to systems and techniques for generating a disparity map based on stereo images of a scene.

### BACKGROUND

Various image processing techniques are available to find depths of a scene in an environment using image capture devices. The depth data may be used, for example, to control augmented reality, robotics, natural user interface technology, gaming and other applications.

Block-matching is an example of a stereo-matching process in which two images (a stereo image pair) of a scene taken from slightly different viewpoints are matched to find disparities (differences in position) of image elements which depict the same scene element. The disparities provide information about the relative distance of the scene elements from the camera. Stereo matching enables disparities (i.e., distance data) to be computed, which allows depths of surfaces of objects of a scene to be determined. A stereo camera including, for example, two image capture devices separated from one another by a known distance can be used to capture the stereo image pair.

In some instances, some pixels may not be assigned a disparity value at all, such that the resulting disparity map (i.e., distance map) is sparsely populated. For example, in block-matching techniques, disparity information is computed from a pair of stereo images of a scene by first computing the distance in pixels between the location of a feature in one image and the location of the same or substantially same feature in the other image. Thus, the second image is searched to identify the closest match for a small region (i.e., block of pixels) in the first image. Although the closest matching block may encompass pixels corresponding to different objects or features that have different disparities, a disparity value typically is assigned only to the block's centroid to reduce computational complexity. Although global optimization and full disparity map algorithms can alleviate the foregoing problems, they tend to require more computational power, and generally are slower and more expensive.

In general, the size of the regions (i.e., blocks) used in block-matching techniques all have the same size (e.g., 9×9 or 11×11 pixels) and are pre-set according, for example, to the local statistics of the image (e.g., level of texture). In some cases, larger size blocks are chosen to reduce the likelihood of incorrect matching being the reference and search images. On the other hand, because the disparity value is assigned only to the block's centroid, using large block sizes tends to result in the thickening or blurring of edges or other features, a known problem in block-matching techniques.

### SUMMARY

The present disclosure describes techniques for generating a disparity map for image elements (e.g., pixels) of an image capture device.

In one aspect, for example, first and second stereo images are acquired. The first image is partitioned into multiple segments, wherein each segment consists of image elements that share one or more characteristics in common. A segmentation map is generated in which each of the image elements is associated with a corresponding one of the segments to which it belongs. A respective disparity value is determined for each of the segments with respect to a corresponding portion of the second image. The disparity value determined for each particular segment is assigned to at least one image element that belongs to that segment, and preferably is assigned to all of the image elements within that segment in order to reduce sparseness. A disparity map indicative of the assigned disparity values then is generated.

In accordance with another aspect, an apparatus includes first and second image capture devices to acquire, respectively, first and second stereo images. A segmentation engine includes one or more processors configured to partition the first image into multiple segments, wherein each segment consists of image elements that share one or more characteristics in common. The segmentation engine also is configured to generate a segmentation map in which each of the image elements is associated with a corresponding one of the segments to which it belongs. A segment matching engine including one or more processor is configured to determine a respective disparity value for each of the segments with respect to a corresponding portion of the second image, to assign the disparity value determined for each particular segment to at least one image element that belongs to that segment (and preferably to all of the image elements within that segment in order to reduce sparseness), and to generate a disparity map indicative of the assigned disparity values.

Various implementations include one or more of the following features. For example, the size and/or shape of the segments can vary from one segment to another. In some instances, each segment consists of a contiguous or connected group of image elements that share at least one of the following characteristics in common: color, intensity, or texture.

The segmentation map can be generated, for example, by assigning a respective label to each image element, wherein each image element belonging to particular one of the segments is assigned the same label.

Determining a respective disparity value for each of the segments can include, for example: comparing each of the segments to the second image; identifying, for each segment, a respective closest matching portion of the second image; and assigning, to each segment of the first image, a respective disparity value that represents a distance between a center of the segment and a center of the respective closest matching portion of the second image. Identifying a closest match for a particular segment can include, for example, selecting a portion of the second image having the lowest sum of absolute differences value with respect to the particular segment.

In some implementations, the disparity map can be displayed on a display device, wherein different disparity values are represented by different visual indicators. For example, the disparity map can be displayed as a three-dimensional color image, wherein different colors are indicative of different disparity values. The disparity map can be used in other applications as well, including distance determinations or gesture recognition. For example, the resulting distance map can be advantageously used in conjunction with image recognition to provide an alert to the driver of a vehicle, or to decelerate the vehicle so as to avoid a collision.

The various engines can be implemented, for example, in hardware (e.g., one or more processors or other circuitry) and/or software.

Various implementations can provide one or more of the following advantages. For example, some implementations can help mitigate edge and feature thickening, and in some instances can also help reduce sparseness of the disparity map.

Other aspects, features and advantages will be readily apparent from the following detailed description, the accompanying drawings and the claims.

### BRIEF DESCRIPTION OF THE DRAWINGS

FIG. 1 is an example of a system for generating a disparity map using stereo images.

FIG. 2 is a flow chart of a method for generating a disparity map using stereo images.

FIG. 3 illustrates an example of a segmentation algorithm.

FIG. 4 illustrates an example of a segment matching algorithm.

FIG. 5 is a flow chart of another method for generating a disparity map using stereo images.

### DETAILED DESCRIPTION

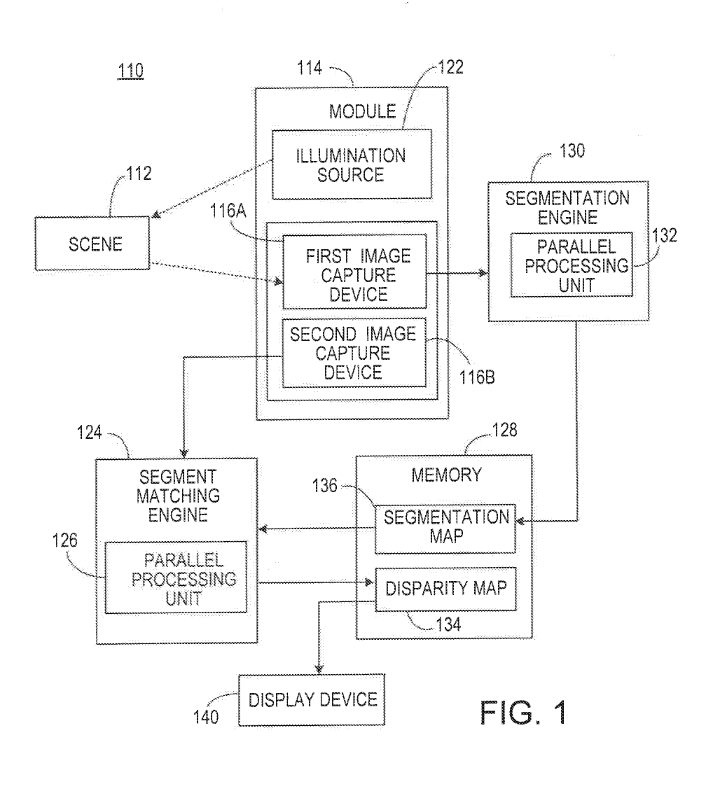

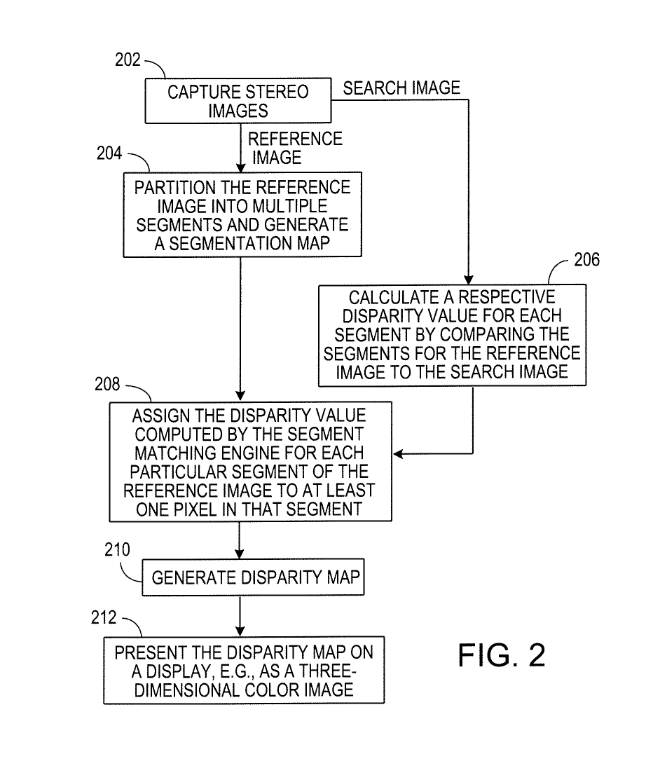

FIG. 1 illustrates an example of a system 110 for generating a disparity map based on captured stereo images of a scene 112. The system can include an optoelectronic module 114 that captures stereo image data of a scene (see also FIG. 2, block 202). For example, the module 114 can have two or more stereo image capture devices 116A, 116B (e.g., CMOS image sensors or CCD image sensors) to acquire images of the scene 112. An image acquired by a first one of the stereo imagers 116A is used as a reference image; an image acquired by a second one of the stereo imagers 116B is used as a search image.

In some cases, the module 114 also may include an associated illumination source 122 arranged to project a pattern of illumination onto the scene 112. When present, the illumination source 122 can include, for example, an infra-red (IR) projector, a visible light source or some other source operable to project a pattern (e.g., of dots or lines) onto objects in the scene 112. The illumination source 122 can be implemented, for example, as a light emitting diode (LED), an infra-red (IR) LED, an organic LED (OLED), an infra-red (IR) laser or a vertical cavity surface emitting laser (VCSEL).

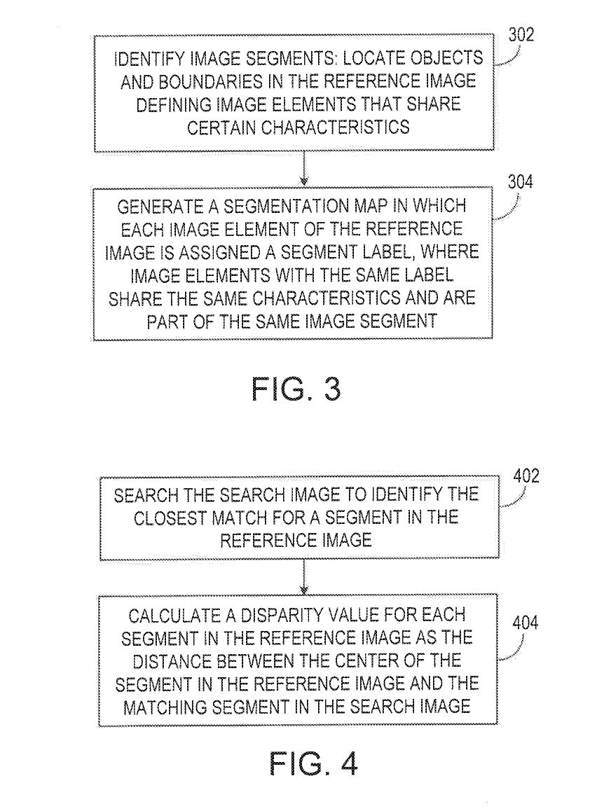

The reference image acquired by the first image capture device 116A is provided to an image segmentation engine 130, which partitions the reference image into multiple segments (i.e., groups of image elements) and generates a segmentation map (FIG. 2, block 204). In particular, as indicated by FIG. 3, the image segmentation engine 130 locates objects and boundaries (lines, curves, etc.) in the reference image and assigns a label to every image element (e.g., pixel) in the reference image such that image elements with the same label share certain characteristics (block 302). Thus, image segmentation produces a segmented image (i.e., a set of segments, typically non-overlapping, that collectively cover the entire image) in which each segment consists of a contiguous/connected group of image elements. Each of the image elements in a given segment are similar with respect to some characteristic or computed property, such as color, intensity, or texture. Generally, adjacent segments are significantly different with respect to the same characteristic(s). Further, the size and shape of the segments is not predetermined by the segmentation algorithm itself. Instead, as the number of pixels included in each particular segment depends on the content of the reference image as well as the characteristics or properties used by the segmentation algorithm, the segments typically will not have a uniform size or shape. In other words, the size and shape of the various segments for a given reference image may differ from one another. The segmentation engine 130 generates a segmentation map 136 in which each image element of the reference image is assigned a segment label corresponding to the segment to which the image element belongs (FIG. 3, block 304). The segmentation map 136 can be stored, for example, in memory 128. The segmentation engine 130 can be implemented, for example, using a computer and can include a parallel processing unit 132 (e.g., an application specific integrated circuit (ASIC) or a field programmable gate array (FPGA))

The segmentation map 136 generated by the segmentation engine 130, as well as the search image acquired by the second image capture device 116B, are provided to a segment matching engine 124, which calculates a disparity value for each segment (FIG. 2, block 206). The segment matching engine 124 executes a segment matching algorithm, in other words, a block-matching or other stereo matching technique in which the non-uniform size and shape segments defined by the segmentation map 136 are used instead of pixel blocks of fixed, predetermined size and shape. An example of the segment matching algorithm is described next.

As indicated by FIG. 4, which shows an example of the segment matching algorithm, disparity information can be calculated by computing the distance in pixels between the location of a segment in the reference image and the location of the same, or substantially same, segment in the search image. Thus, the segment matching engine searches the search image to identify the closest match for a segment in the reference image (block 402).

Various techniques can be used to determine how similar segments in the two images are, and to identify the closest match. One such known technique is the “sum of absolute differences,” sometime referred to as “SAD.” To compute the sum of absolute differences, a grey-scale value for each pixel in the reference segment is subtracted from the grey-scale value of the corresponding pixel in the search segment, and the absolute value of the differences is calculated. Then, all the differences are summed to provide a single value that roughly measures the similarity between the segments. A lower value indicates the segments are more similar. To find the segment that is “most similar” to the template, the SAD values between the template and each segment in the search image is computed, and the segment in the search image with the lowest SAD value is selected. A respective disparity value then is assigned to each segment of the reference image, where the disparity value refers to the distance between the centers of the matching segments in the two images (block 404). In other implementations, other matching techniques may be used to generate the disparity map.

The disparity value computed by the segment matching engine 124 for each particular segment of the reference image is assigned to at least one pixel in that segment. For example, in some implementations, the disparity value may be assigned only to the centroid pixel in that segment (FIG. 2, block 208). Based on these disparity values, the segment matching engine 124 generates a disparity map 134, which indicates the disparity values for each of the segments of the reference image (FIG. 2, block 210). The disparity map 134 can be stored in the memory 128. The disparity values are related to distances from the image capturing devices 116A, 116B to surfaces of the object(s) in the scene 112 and thus are indicative of the respective depths of surfaces in the scene for each segment. In implementations in which disparity values are assigned only to the centroid pixel of each segment of the reference image, the segment matching engine 124 generates a disparity value for fewer than all the image elements (i.e., pixels) and thus the disparity map 134 is relatively sparse. By performing the matching algorithm on segments of the image as described above, instead of using block of a fixed, predetermined size and shape, the edge and feature thickening problem mentioned above can, in some cases, be alleviated.

The segment matching engine 124 can be implemented, for example, using a computer and can include a parallel processing unit 126 (e.g., an application specific integrated circuit (ASIC) or a field programmable gate array (FPGA)). Although the various engines 124, 130 and memory 128 are shown in FIG. 1 as being separate from the module 114, in some implementations they may be integrated as part of the module 114. For example, the engines 124, 130 and memory 128 may be implemented as one or more integrated circuit chips mounted on a printed circuit board (PCB) within the module 114, along with the image capture devices 116A, 116B. In other instances, the engines can be implemented in a processor of the mobile device (e.g., smartphone) in which the module 114 is disposed. In some cases, the illumination source 122 (if present) may be separate from the module 114 that houses the image capture devices 116A, 116B. Further, the module 114 also can include other processing and control circuitry to control, for example, the timing of when the image capture devices 116A, 116B acquire images. Such circuitry also can be implemented, for example, in one or more integrated circuit chips mounted on the same PCB as the image capture devices 116.

The disparity map 134 can be provided to a display device 140, which graphically presents the disparity map, for example, as a three-dimensional color image. (FIG. 2, block 212). Thus, different disparity values (or ranges of values) can be converted and represented graphically by different, respective colors. In some implementations, different disparity values are represented graphically on the disparity map by different cross-hatching or other visual indicators.

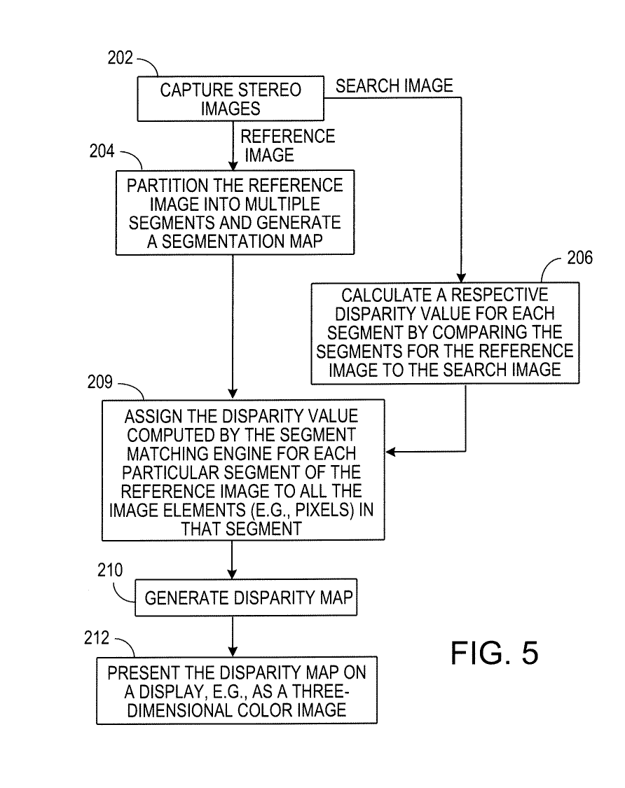

As noted above, if disparity values are assigned only to the centroid pixel of each segment of the reference image, the resulting disparity map 134 will be relatively sparse. Further, the centroid would have to be calculated, which in some cases, may not be trivial (e.g., where the segments are irregularly shaped). Also, if the segment is has an irregular shape, the centroid may not occur inside the shape. To obtain a disparity map that is less sparse and that can avoid these other issues, the disparity value calculated by the matching engine 124 for each particular segment of the reference image is assigned to all the image elements (i.e., pixels) of the particular segment, not just the centroid pixel. FIG. 5 is a flow chart of such a method and is substantially the same as FIG. 2, with block 209 replacing block 208. In this case, the resulting disparity map 134 (block 210) defines a disparity value for each and every image element of the reference image (i.e., not only for the centroids). Thus, the technique illustrated by FIG. 5 can, in some cases, generate a disparity map that alleviates the edge and feature thickening problem, and also is less sparse.

The techniques described here may be suitable, in some cases, for real-time applications in which the output of a computer process (i.e., rendering) is presented to the user such that the user observes no appreciable delays that are due to computer processing limitations. For example, the techniques may be suitable for real-time applications on the order of about at least 30 frames per second or near real-time applications on the order of about at least 5 frames per second.

In some implementations, the disparity map can be used as input for distance determination. For example, in the context of the automotive industry, the disparity map can be used in conjunction with image recognition techniques that identify and/or distinguish between different types of objects (e.g., a person, animal, or other object) appearing in the path of the vehicle. The nature of the object (as determined by the image recognition) and its distance from the vehicle (as indicated by the disparity map) may be used by the vehicle's operating system to generate an audible or visual alert to the driver, for example, of an object, animal or pedestrian in the path of the vehicle. In some cases, the vehicle's operating system can decelerate the vehicle automatically to avoid a collision.

The techniques described here also can be used advantageously for gesture recognition applications. For example, the disparity map generated using the present techniques can enhance the ability of the module or mobile device to distinguish between different digits (i.e., fingers) of a person's hand. This can facilitate the use of gestures that are distinguished from one another based, for example, on the number of fingers (e.g., one, two or three) extended. Thus, a gesture using only a single extended finger could be recognized as a first type of gesture that triggers a first action by the mobile device, whereas a gesture using two extended fingers could be recognized as a second type of gesture that triggers a different second action by the mobile device. Similarly, a gesture using only three extended finger could be recognized as a third type of gesture that triggers a different third action by the mobile device.

Various implementations described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various modifications and combinations of the foregoing features will be readily apparent from the present description and are within the spirit of the invention. Accordingly, other implementations are within the scope of the claims.

1. A method of providing a disparity map, the method comprising:
acquiring first and second stereo images;
partitioning the first image into multiple segments, wherein each segment consists of image elements that share one or more characteristics in common;
generating a segmentation map in which each of the image elements is associated with a corresponding one of the segments to which it belongs;
determining a respective disparity value for each of the segments with respect to a corresponding portion of the second image; and
assigning the disparity value determined for each particular segment to at least one image element that belongs to that segment; and
generating a disparity map indicative of the assigned disparity values.

2. The method of claim 1 wherein at least one of size or shape of the segments vary from one segment to another.

3. The method of claim 1 further including displaying on a display device the disparity map, wherein different disparity values are represented by different visual indicators.

4. The method of claim 3 wherein the disparity map is displayed as a three-dimensional color image, wherein different colors are indicative of different disparity values.

5. The method of claim 1 wherein each segment consists of a contiguous group of image elements that share at least one of the following characteristics in common: color, intensity, or texture.

6. The method of claim 1 generating a segmentation map includes assigning a respective label to each image element, wherein each image element belonging to particular one of the segments is assigned the same label.

7. The method of claim 1 wherein determining a respective disparity value for each of the segments includes:
comparing each of the segments to the second image;
identifying, for each segment, a respective closest matching portion of the second image; and
assigning, to each segment of the first image, a respective disparity value that represents a distance between a center of the segment and a center of the respective closest matching portion of the second image.

8. The method of claim 7 wherein identifying a closest match for a particular segment includes selecting a portion of the second image having the lowest sum of absolute differences value with respect to the particular segment.

9. The method of claim 1 wherein the disparity value determined for each particular segment is assigned only to a centroid image element belonging to that particular segment.

10. The method of claim 1 wherein the disparity value determined for each particular segment is assigned to each image element belonging to that particular segment.

11. An apparatus for providing a disparity map, the apparatus comprising:
first and second image capture devices to acquire, respectively, first and second stereo images;
a segmentation engine comprising one or more processors configured to:
partition the first image into multiple segments, wherein each segment consists of image elements that share one or more characteristics in common; and
generate a segmentation map in which each of the image elements is associated with a corresponding one of the segments to which it belongs; and
a segment matching engine comprising one or more processors configured to:
determine a respective disparity value for each of the segments with respect to a corresponding portion of the second image;
assign the disparity value determined for each particular segment to at least one image element that belongs to that segment; and
generate a disparity map indicative of the assigned disparity values.

12. The apparatus of claim 11 wherein at least one of size or shape of the segments vary from one segment to another.

13. The apparatus of claim 11 further including a display device configured to display the disparity map, wherein different disparity values are represented by different visual indicators.

14. The apparatus of claim 13 wherein the disparity map is displayed on the display device as a three-dimensional color image, wherein different colors are indicative of the disparity values.

15. The apparatus of claim 11 wherein each segment consists of a contiguous group of image elements that share at least one of the following characteristics in common: color, intensity, or texture.

16. The apparatus of claim 11 wherein the segmentation engine is configured to assign a respective label to each image element, wherein each image element belonging to particular one of the segments is assigned the same label.

17. The apparatus of claim 11 wherein the segment matching engine is configured to:
compare each of the segments to the second image;
identify, for each segment, a respective closest matching portion of the second image; and
assign, to each segment of the first image, a respective disparity value that represents a distance between a center of the segment and a center of the respective closest matching portion of the second image.

18. The apparatus of claim 17 wherein the segment matching engine is configured to identify a closest match for a particular segment by selecting a portion of the second image having the lowest sum of absolute differences value with respect to the particular segment.

19. The apparatus of claim 11 wherein the segment matching engine is configured to assign the disparity value determined for each particular segment only to a centroid image element belonging to that particular segment.

20. The apparatus of claim 11 wherein the segment matching engine is configured to assign the disparity value determined for each particular segment to each image element belonging to that particular segment.
